(19) United States
(12) Patent Application Publication
(10) Pub. No.: US 2026/0044138 A1
(43) Pub. Date: Feb. 12, 2026

(54) SYSTEMS, APPARATUSES, METHODS, AND COMPUTER PROGRAM PRODUCTS FOR INITIATING PERFORMANCE OF ONE OR MORE ITEM RELATED ACTIONS

(71) Applicant: Honeywell International Inc., Charlotte, NC (US)

(72) Inventors: Ivan Borastero Villan, St. Germaine-en-Laye (FR); Sunil Anthon Bardeskar, Bangalore (IN); Ananda Vel Murugan Chandra Mohan, Madurai (IN)

(21) Appl. No.: 18/911,742

(22) Filed: Oct. 10, 2024

(30) Foreign Application Priority Data
Aug. 9, 2024 (IN) 202411060332

(51) Int. Cl. G05B 19/418

(52) U.S. Cl. CPC G05B 19/41845; G05B 19/4183

(57) ABSTRACT

A method provided herein includes determining one or more available field spaces using a field item feature structure. In some embodiments, the method includes generating first reconfiguration data by applying one or more images associated with a first item to a tear down machine learning component of a composite machine learning model. In some embodiments, the method includes generating second reconfiguration data by applying the one or more images and external related item data to a comparative machine learning component of the composite machine learning model. In some embodiments, the method includes generating new item data by applying a first portion of the first reconfiguration data to an implementation machine learning component of the composite machine learning model. In some embodiments, the method includes initiating performance of one or more item related actions based on the first reconfiguration data, the second reconfiguration data, or the new item data.

### CROSS REFERENCE TO RELATED APPLICATIONS

This application claims the benefit of India Provisional Application No. 202411060332 filed Aug. 9, 2024, and entitled “SYSTEMS, APPARATUSES, METHODS, AND COMPUTER PROGRAM PRODUCTS FOR INITIATING PERFORMANCE OF ONE OR MORE ITEM SET OPTIMIZATION ACTIONS,” which is hereby incorporated by reference in its entirety.

### TECHNOLOGICAL FIELD

Embodiments of the present disclosure relate generally to systems, apparatuses, methods, and computer program products for initiating performance of one or more item related actions.

### BACKGROUND

Applicant has identified many technical challenges and difficulties associated with systems, apparatuses, methods, and computer program products for item optimization and/or item generation. Through applied effort, ingenuity, and innovation, Applicant has solved problems related to systems, apparatuses, methods, and computer program products for item optimization and/or item generation by developing solutions embodied in the present disclosure, which are described in detail below.

### BRIEF SUMMARY

Various embodiments described herein relate to systems, apparatuses, methods, and computer program products for initiating performance of one or more item related actions.

In accordance with one aspect of the disclosure, a method is provided. In some embodiments, the method includes determining one or more available field spaces using a field item feature structure, wherein the field item feature structure is associated with a plurality of items. In some embodiments, the method includes generating first reconfiguration data by applying one or more images associated with a first item to a tear down machine learning component of a composite machine learning model. In some embodiments, the method includes generating second reconfiguration data by applying the one or more images and external related item data to a comparative machine learning component of the composite machine learning model. In some embodiments, the external related item data is associated with a related item. In some embodiments, the first reconfiguration data and the second reconfiguration data are associated with at least one of the one or more available field spaces. In some embodiments, the method includes generating new item data by applying a first portion of the first reconfiguration data to an implementation machine learning component of the composite machine learning model. In some embodiments, the method includes initiating performance of one or more item related actions based on the first reconfiguration data, the second reconfiguration data, or the new item data.

In some embodiments, the field item feature structure comprises item feature data and one or more field item predictions.

In some embodiments, the method includes generating the field item feature structure.

In some embodiments, generating the field item feature structure includes receiving the item feature data representative of a plurality of item configuration features associated with the first item.

In some embodiments, generating the field item feature structure includes determining the one or more field item predictions by applying at least a portion of the item feature data to an item hub machine learning component of the composite machine learning model.

In some embodiments, the method includes extracting the external related item data from one or more external sources using a related item extraction machine learning component of the composite machine learning model.

In some embodiments, the tear down machine learning component is configured to perform one or more computer vision techniques.

In some embodiments, determining the one or more available field spaces comprises performing a mining technique on the field item feature structure.

In some embodiments, generating the new item data includes identifying a first available field space of the one or more available field spaces.

In some embodiments, generating the new item data includes determining that the first item does not match the first available field space of the one or more available field spaces.

In some embodiments, generating the new item data includes identifying a second item.

In some embodiments, generating the new item data includes determining that the second item matches the first available field space of the one or more available field spaces.

In some embodiments, initiating performance of the one or more item related actions includes generating an item optimization interface component.

In some embodiments, the item optimization interface component comprises one or more of the first reconfiguration data, the second reconfiguration data, or the new item data.

In some embodiments, initiating performance of the one or more item related actions includes causing the item optimization interface component to be rendered to an item optimization interface.

In some embodiments, initiating performance of the one or more item related actions includes causing an item inventory record to be modified.

In some embodiments, initiating performance of the one or more item related actions includes generating a first item and a related item comparison report.

In accordance with another aspect of the disclosure, an apparatus is provided. In some embodiments, the one or more processors are configured to determine one or more available field spaces using a field item feature structure, wherein the field item feature structure is associated with a plurality of items. In some embodiments, the one or more processors are configured to generate first reconfiguration data by applying one or more images associated with a first item to a tear down machine learning component of a composite machine learning model. In some embodiments, the one or more processors are configured to generate second reconfiguration data by applying the one or more images and external related item data to a comparative machine learning component of the composite machine learning model. In some embodiments, the external related item data is associated with a related item. In some embodiments, the first reconfiguration data and the second reconfiguration data are associated with at least one of the one or more available field spaces. In some embodiments, the one or more processors are configured to generate new item data by applying a first portion of the first reconfiguration data to an implementation machine learning component of the composite machine learning model. In some embodiments, the one or more processors are configured to initiate performance of one or more item related actions based on the first reconfiguration data, the second reconfiguration data, or the new item data.

In some embodiments, the field item feature structure comprises item feature data and one or more field item predictions.

In some embodiments, the one or more processors are further configured to generate the field item feature structure.

In some embodiments, to generate the field item feature structure the one or more processors are further configured to receive the item feature data representative of a plurality of item configuration features associated with the first item.

In some embodiments, to generate the field item feature structure the one or more processors are further configured to determine the one or more field item predictions by applying at least a portion of the item feature data to an item hub machine learning component of the composite machine learning model.

In some embodiments, to generate the new item data the one or more processors are further configured to identify a first available field space of the one or more available field spaces.

In some embodiments, to generate the new item data the one or more processors are further configured to determine that the first item does not match the first available field space of the one or more available field spaces.

In some embodiments, to generate the new item data the one or more processors are further configured to identify a second item.

In some embodiments, to generate the new item data the one or more processors are further configured to determine that the second item matches the first available field space of the one or more available field spaces.

In some embodiments, to initiate performance of the one or more item related actions the one or more processors are further configured to generate an item optimization interface component.

In some embodiments, the item optimization interface component comprises one or more of the first reconfiguration data, the second reconfiguration data, or the new item data.

In some embodiments, to initiate performance of the one or more item related actions the one or more processors are further configured to cause the item optimization interface component to be rendered to an item optimization interface.

In some embodiments, to initiate performance of the one or more item related actions the one or more processors are further configured to cause an item inventory record to be modified.

In some embodiments, to initiate performance of the one or more item related actions the one or more processors are further configured to generate a first item and a related item comparison report.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for determining one or more available field spaces using a field item feature structure, wherein the field item feature structure is associated with a plurality of items. In some embodiments, the computer program code, in execution with at least one processor, configures the computer program product for generating first reconfiguration data by applying one or more images associated with a first item to a tear down machine learning component of a composite machine learning model. In some embodiments, the computer program code, in execution with at least one processor, configures the computer program product for generating second reconfiguration data by applying the one or more images and external related item data to a comparative machine learning component of the composite machine learning model. In some embodiments, the external related item data is associated with a related item. In some embodiments, the first reconfiguration data and the second reconfiguration data are associated with at least one of the one or more available field spaces. In some embodiments, the computer program code, in execution with at least one processor, configures the computer program product for generating new item data by applying a first portion of the first reconfiguration data to an implementation machine learning component of the composite machine learning model. In some embodiments, the computer program code, in execution with at least one processor, configures the computer program product for initiating performance of one or more item related actions based on the first reconfiguration data, the second reconfiguration data, or the new item data.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 illustrates an exemplary block diagram of an environment in which embodiments of the present disclosure may operate;

FIG. 2 illustrates an exemplary block diagram of an example apparatus that may be specially configured in accordance with one or more embodiments of the present disclosure;

FIG. 3 illustrates an architecture of an example item optimization and generation device in accordance with one or more embodiments of the present disclosure;

FIG. 4 illustrates an example interface in accordance with one or more embodiments of the present disclosure;

FIG. 5 illustrates a flowchart of an example method in accordance with one or more embodiments of the present disclosure;

FIG. 6 illustrates a flowchart of an example method in accordance with one or more embodiments of the present disclosure; and

FIG. 7 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration. ” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with systems, apparatuses, methods, and computer program products for item optimization and/or new item generation. As would be understood by one skilled in the field to which this disclosure pertains, there are numerous example scenarios in which systems, apparatuses, methods, and computer program products for item optimization and/or new item generation are desirable.

In many applications, it may be desirable to use systems, apparatuses, methods, and computer program products for item optimization and/or new item generation. For example, it may be desirable to use systems, apparatuses, methods, and computer program products for item optimization and/or new item generation to modify items such that items are more efficient, lighter, and have greater capabilities. In some implementations, it may be desirable to use systems, apparatuses, methods, and computer program products that are configured to perform item optimization and/or new item generation using tear down images of items and/or for available field spaces.

Example solutions for item optimization and/or new item generation include using one or more databases and/or one or more computing devices to perform item optimization and/or new item generation. However, such example solutions are inefficient, reactive, simplistic, and technically deficient. For example, such example solutions are inefficient because such example solutions do not use a composite machine learning model that includes a plurality of specifically configured components for performing particular functions of item optimization and/or new item generation. As a result, such example solutions cause computing devices and databases to suffer from high latency, consume excessive processing power, and consume excessive memory. As another example, such example solutions are reactive because such example solutions are unable to automatically implement item related actions. In this regard, such example solutions are unable to automatically implement item related actions that automatically cause item inventory records to be modified and/or a first item and a related item comparison report to be generated. As another example, such example solutions are simplistic because such example solutions are unable to determine available field spaces. As another example, such example solutions are technically deficient because such example solutions are unable to determine and/or predict one or more field item predictions because determining field item predictions often requires capabilities beyond inner joins, outer joins, right joins, and/or left joins provided by such example solutions. For example, such example solutions that use an SQL database are unable to determine and/or predict one or more field item predictions. Accordingly, there is a need for systems, apparatuses, methods, and computer program products that are able to perform item optimization and/or new item generation in an efficient, a proactive, a sophisticated, and a technically sufficient manner.

Thus, to address these and/or other issues related to systems, apparatuses, methods, and computer program products for item optimization and/or new item generation, example systems, apparatuses, methods, and computer program products for initiating performance of one or more item related actions are disclosed herein. For example, an embodiment in this disclosure, described in greater detail below, includes a method that includes determining one or more available field spaces using a field item feature structure. In some embodiments, the first item feature structure is associated with a plurality of items. In some embodiments, the method includes generating first reconfiguration data by applying one or more images associated with a first item to a tear down machine learning component of a composite machine learning model. In some embodiments, the method includes generating second reconfiguration data by applying the one or more images and external related item data to a comparative machine learning component of the composite machine learning model. In some embodiments, the external related item data is associated with a related item. In some embodiments, the first reconfiguration data and the second reconfiguration data are associated with at least one of the one or more available field spaces. In some embodiments, the method includes generating new item data by applying a first portion of the first reconfiguration data to an implementation machine learning component of the composite machine learning model. In some embodiments, the method includes initiating performance of one or more item related actions based on the first reconfiguration data, the second reconfiguration data, or the new item data. Accordingly, the systems, apparatuses, methods, and computer program products provided herein are able to perform item optimization and/or new item generation in an efficient, a proactive, a sophisticated, and a technically sufficient manner.

### Example Systems and Apparatuses

Embodiments of the present disclosure herein include systems, apparatuses, methods, and computer program products configured for initiating performance of one or more item related actions. For example, embodiments of the present disclosure herein may include systems, apparatuses, methods, and computer program products configured for item optimization and/or new item generation using value engineering (VE) and/or component engineering (CE). In some embodiments, value engineering and/or component engineering includes facilitating the lifecycle management of an item. It should be readily appreciated that the embodiments of the apparatus, systems, methods, and computer program product described herein may be configured in various additional and alternative manners in addition to those expressly described herein.

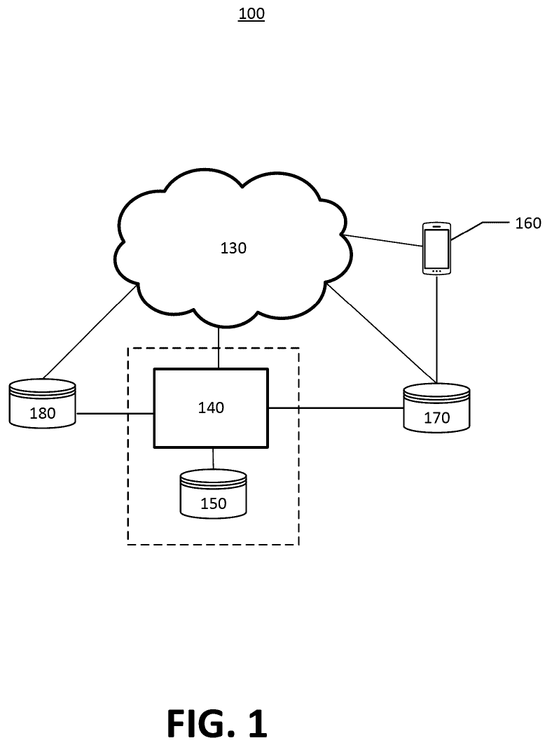

FIG. 1 illustrates an exemplary block diagram of an environment in which embodiments of the present disclosure may operate. In some embodiments, the environment 100 includes an item optimization and generation device 140. In some embodiments, the item optimization and generation device 140 is electronically and/or communicatively coupled to an internal item feature database 150, an external item feature database 170, one or more external sources 180, and/or a user device 160. The item optimization and generation device 140 may be located remotely from the internal item feature database 150, the external item feature database 170, one or more external sources 180, and/or the user device 160. In some embodiments, the item optimization and generation device 140 may be located in a remote cloud server and electronically and/or communicatively coupled to the internal item feature database 150, the external item feature database 170, one or more external sources 180, and/or user device 160 via at least a network 130. In some embodiments, the item optimization and generation device 140 is configured via hardware, software, firmware, and/or a combination thereof, to perform data intake of one or more types of data, such as item feature data and/or the like.

Additionally, or alternatively, in some embodiments, the item optimization and generation device 140 is configured via hardware, software, firmware, and/or a combination thereof, to generate and/or transmit command(s) that control, adjust, or otherwise impact operations of the one or more of the internal item feature database 150, one or more external sources 180, the external item feature database 170, the item optimization and generation device 140, and/or the user device 160. For example, the item optimization and generation device 140 may be configured to initiate performance of one or more item related actions. Additionally, or alternatively, in some embodiments, the item optimization and generation device 140 is configured via hardware, software, firmware, and/or a combination thereof, to perform data reporting, provide data, and/or other data output process(es) associated with monitoring or otherwise analyzing operations of one or more of the one or more of the internal item feature database 150, one or more external sources 180, the external item feature database 170, the item optimization and generation device 140, and/or the user device 160. For example, in various embodiments, the item optimization and generation device 140 may be configured to execute and/or perform one or more operations and/or functions described herein.

The user device 160 may be associated with users of the item optimization and generation device 140. In various embodiments, the item optimization and generation device 140 may generate and/or transmit a message, alert, or indication to a user via the user device 160. Additionally, or alternatively, the user device 160 may be utilized by a user to remotely access the item optimization and generation device 140. This may be by, for example, an application operating on the user device 160.

The external item feature database 170 may be configured to receive, store, and/or transmit data. In various embodiments, the external item feature database 170 may be associated with data associated with the item optimization and generation device 140, one or more external sources 180, the internal item feature database 150, and/or the user device 160. Additionally, or alternatively, in some embodiments the external item feature database 170 stores user inputted data. The external item feature database 170 may be located remotely from the user device 160, the internal item feature database 150, one or more external sources 180, and/or the item optimization and generation device 140, in proximity of the user device 160 and/or the item optimization and generation device 140, one or more external sources 180, the internal item feature database 150, and/or within the user device 160, one or more external sources 180, the internal item feature database 150, and/or the item optimization and generation device 140.

The internal item feature database 150 may be configured to receive, store, and/or transmit data. In various embodiments, the internal item feature database 150 may be associated with data associated with the item optimization and generation device 140, one or more external sources 180, the external item feature database 170, and/or the user device 160. Additionally, or alternatively, in some embodiments the internal item feature database 150 stores user inputted data. The internal item feature database 150 may be located remotely from the user device 160, one or more external sources 180, the external item feature database 170, and/or the item optimization and generation device 140, in proximity of the user device 160 and/or the item optimization and generation device 140, the external item feature database 170, and/or within the user device 160, the external item feature database 170, and/or the item optimization and generation device 140.

The one or more external sources 180 may be configured to receive, store, and/or transmit data. In various embodiments, the one or more external sources 180 may be associated with data associated with the item optimization and generation device 140, internal item feature database 150, the external item feature database 170, and/or the user device 160. Additionally, or alternatively, in some embodiments the one or more external sources 180 stores user inputted data. The one or more external sources 180 may be located remotely from the user device 160, the external item feature database 170, the internal item feature database 150, and/or the item optimization and generation device 140, in proximity of the user device 160 and/or the item optimization and generation device 140, the internal item feature database 150, the external item feature database 170, and/or within the user device 160, the external item feature database 170, the internal item feature database 150, and/or the item optimization and generation device 140.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the item optimization and generation device 140 may include internal item feature database 150.

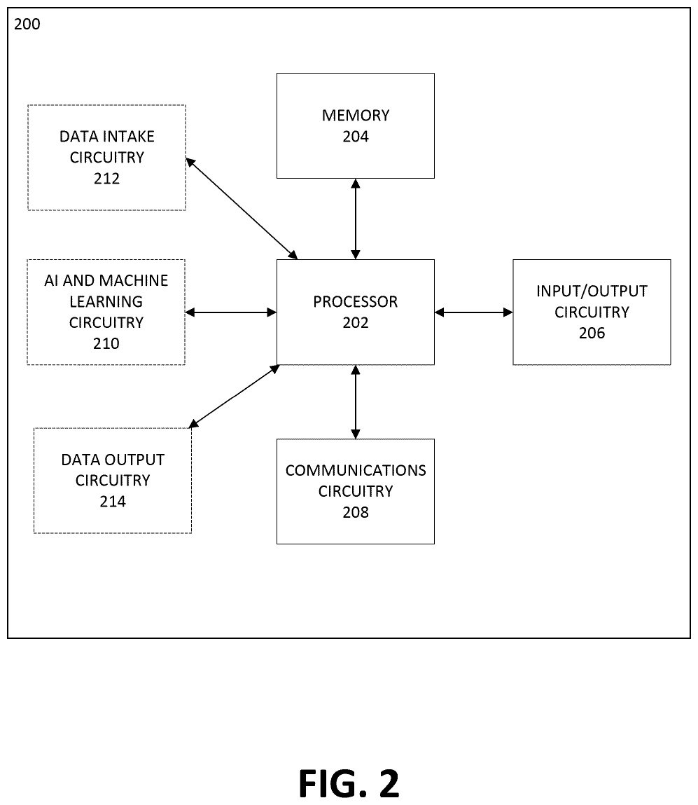

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. Examples of an apparatus 200 may include, but is not limited to, the internal item feature database 150, the item optimization and generation device 140, and/or the user device 160. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as an computing apparatus 200 of the internal item feature database 150, one or more external sources 180, the external item feature database 170, the item optimization and generation device 140, and/or the user device 160 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuity 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the internal item feature database 150, the item optimization and generation device 140, and/or the user device 160. In some embodiments, the data intake circuitry 212 includes hardware, software, firmware, and/or a combination thereof, that communicates with one or more components of the internal item feature database 150, the external item feature database 170, the item optimization and generation device 140, and/or the user device 160 to receive particular data associated with such operations of the internal item feature database 150, the external item feature database 170, the item optimization and generation device 140, and/or the user device 160. The data intake circuitry 212 may support such operations for the internal item feature database 150, the item optimization and generation device 140, and/or the user device 160. Additionally, or alternatively, in some embodiments, the data intake circuitry 212 includes hardware, software, firmware, and/or a combination thereof, that retrieves particular data associated with the internal item feature database 150, the item optimization and generation device 140, the external item feature database 170, and/or the user device 160.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured to facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect the AI and machine learning circuitry 210.

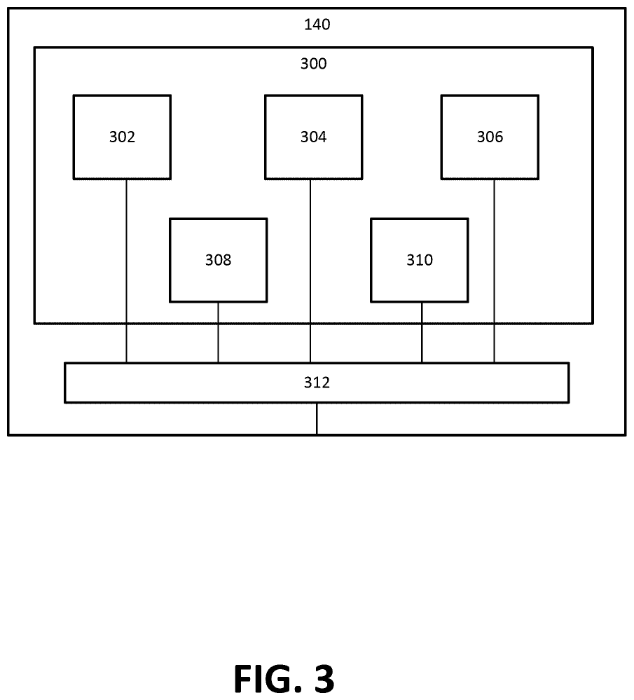

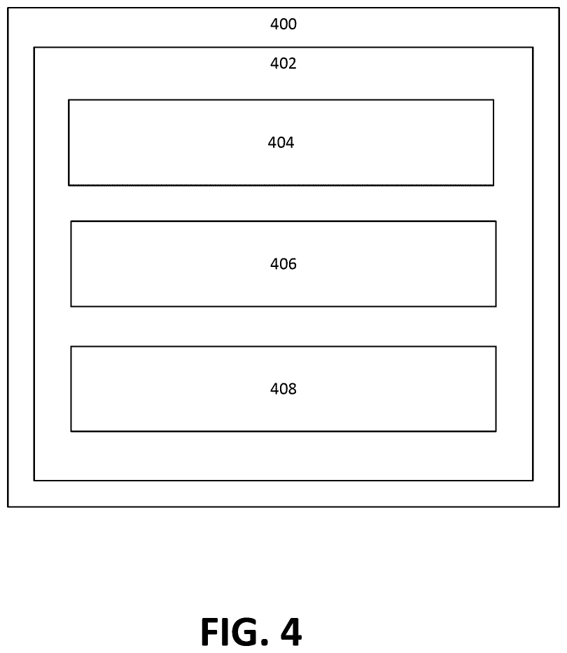

With reference to FIGS. 1-4, in some embodiments, the item optimization and generation device 140 is configured to receive item feature data. In some embodiments, the item feature data is associated with a plurality of items. In some embodiments, an item includes an electrical item, a mechanical item, an electromechanical item, a resin item, and/or the like. For example, an item may include a printed circuit board (PCB), a printed circuit board assembly (PCBA), a sensor, a bar code scanner, and/or the like. In some embodiments, an item includes one or more components that form a portion of an item. For example, a component of an item may include a portion of a printed circuit board (PCB) (e.g., an individual layer of a printed circuit board), a portion of a printed circuit board assembly (PCBA) (e.g., an individual electrical component of a printed circuit board assembly), a portion of a sensor (e.g., a controller of a sensor), a portion of a bar code scanner (e.g., an imagining component of a bar code scanner), and/or the like.

In some embodiments, an item is associated with one or more field spaces. In some embodiments, a field space is a space, an area, a domain, and/or the like in which an item is used or implemented. For example, if an item includes a printed circuit board (PCB), an item may be associated with an electrical applications field space.

In some embodiments, item feature data includes one or more items of data representative and/or indicative of a plurality of item configuration features. For example, item feature data may include one or more items of data representative and/or indicative of a plurality of item configuration features associated with one or more of the plurality of items. In some embodiments, an item configuration feature is a data object that is representative and/or indicative of a feature, characteristic, component, specification, report, schematic, and/or the like associated with an item. In some embodiments, a first part of item feature data is received from the internal item feature database 150. Additionally, or alternatively, a second part of item feature data is received from an external item feature database 170.

In some embodiments, one or more of the plurality of item configuration features are associated with a feature type. In this regard, in some embodiments, the plurality of item configuration features includes one or more item configuration features associated with a general feature type. For example, the one or more item configuration features associated with a general feature type may be representative of an item life cycle (e.g., a life cycle of an item), an item team center (e.g., a team responsible for an item), an enterprise data warehouse (e.g., a data warehouse where information about an item is stored), a transfer volume report for an item, a quality report for an item, implementation issues (e.g., one or more issues associated with using an item for the item's intended purpose), a manufacturing report (e.g., a report indicating a item's quality, an item's yield), new item introduction information (e.g., information indicating requirements for introducing an item), a test report of an item, a component impact value requirement list (e.g., a list of costs associated with components of an item), a provider impact value requirement list (e.g., a provider of an item's cost requirement list), a new item introduction roadmap, a manufacturing sales inventory and operations planning (SIOP) report, financial report margins associated with an item, a preferred provider list (e.g., a list of preferred providers for components of an item), a personal responsibility level (e.g., a level of personal responsible for an item), a tariffs report (e.g., a tariffs report associated with an item), a logistics report (e.g., a report on the logistics of creating and/or distributing an item), an electronics manufacturing services list, an item schematic (e.g., a drawing, such as technical drawing, of an item), an item identification tag (e.g., a data tag that uniquely identifies an item), an item part number (e.g., a part number associated with an item), a raw material impact value (e.g., an impact value (such as a cost, utility, etc.) of a raw material on a per unit basis from which an item may be constructed), an item dimension (e.g., dimensions of an item), a material identification tag (e.g., a data tag that uniquely identifies a particular material that is used in an item), and/or the like.

In some embodiments, the plurality of item configuration features includes one or more configuration features associated with a manufacturing feature type. For example, the one or more item configuration features associated with a manufacturing feature type may be representative of an impact value of manufactured items sold in a time period by stock keeping unit, receiver returns by manufacturing location of an item, yield per stock keeping unit of an item, and/or the like.

In some embodiments, the plurality of item configuration features includes one or more configuration features associated with an engineering feature type. For example, the one or more item configuration features associated with an engineering feature type may be representative of an item requirement specification (e.g., a specification indicating one or more components of an item that are required for the item to function correctly), a type of printed circuit board assembly used in an item (e.g., ECAD, Gerber,), a printed circuit board assembly bill of manufacturing, a 3-dimensional model of an item, a 2-dimensional model of an item, a 3-dimensional model of a component of an item, a 2-dimensional model of a component of an item, a datasheet associated with an item, and/or the like.

In some embodiments, the plurality of item configuration features includes one or more configuration features associated with a logistics feature type. For example, the one or more item configuration features associated with a logistics feature type may be representative of a tariff impact value associated with an item, list of air shipments per stock keeping unit for an item, list of shipments in which an item is transferred in a non-full container, and/or the like.

In some embodiments, the plurality of item configuration features includes one or more configuration features associated with a planning feature type. For example, the one or more item configuration features associated with a planning feature type may be representative of a list of excess inventory of an item over a particular time period, an updated SIOP of components of an item, and/or the like. In some embodiments, the plurality of item configuration features includes one or more configuration features associated with a new item feature type. For example, the one or more item configuration features associated with a new item feature type may be representative of a PG5 impact value improvement plan, a PG3 impact value baseline, and/or the like.

In some embodiments, the plurality of item configuration features includes one or more configuration features associated with a sourcing feature type. For example, the one or more item configuration features associated with a sourcing feature type may be representative of specifications of high impact value components of an item, high volume components for an item, impact value increases in a time period associated with an item, impact value by component of an item, percent of value engineering per item in a time period, percent of component engineering per component in a time period, OEL associated all items of a particular type (e.g., all electrical items), OEL associated all components of an item (e.g., all components of an electrical item), and/or the like.

In some embodiments, the item optimization and generation device 140 is configured to determine one or more field item predictions. For example, the item optimization and generation device 140 may be configured to determine one or more field item predictions to generate a field item feature structure. In some embodiments, a field item prediction is a data object that is representative and/or indicative of an item configuration feature that is not represented in the item feature data and is determined by the item optimization and generation device 140. Said differently, for example, by determining one or more field item predictions, the item optimization and generation device 140 may be configured to use item feature data that represents at least some of the item configuration features in the plurality of item configuration features to determine and/or predict other item configuration features associated with a particular item(s) of the plurality of items.

In some embodiments, the item optimization and generation device 140 is configured to determine one or more field item predictions by applying the item feature data to an item hub machine learning component 302 of a composite machine learning model 300. In this regard, for example, determining one or more field item predictions includes identifying a first item configuration feature of the plurality of item configuration features (e.g., the plurality of item configuration features represented by the item feature data received by the item optimization and generation device 140). For example, determining one or more field item predictions includes identifying a first item configuration feature that is representative of an item schematic. In some embodiments, determining one or more field item predictions includes determining a first field item prediction by applying the first item configuration feature to the item hub machine learning component 302 of the composite machine learning model 300. For example, the first field item prediction may be representative of an item weight (e.g., the weight of an item in the plurality of items). In this regard, for example, the item hub machine learning component 302 of the composite machine learning model 300 is configured to determine an item weight associated with an item of the plurality of items from an item schematic associated with an item of the plurality of items. For example, the item hub machine learning component 302 of the composite machine learning model 300 may be configured to determine an item weight associated with an item from an item schematic when item feature data received by the item optimization and generation device 140 includes an item configuration feature representative of an item schematic but does not include an item configuration feature representative of an item weight.

In some embodiments, for example, determining one or more field item predictions includes identifying a second item configuration feature of the plurality of item configuration features. For example, the second item configuration feature may be a material identification tag. In some embodiments, determining one or more field item predictions includes identifying a third item configuration feature of the plurality of item configuration features. For example, the third item configuration feature may be representative of a raw material impact value. In some embodiments, the third item configuration feature may be identified using the second item configuration feature. In this regard, for example, a material identification tag may be used to determine a raw material impact value associated with a particular material. In some embodiments, determining one or more field item predictions includes determining a second field item prediction by applying the first field item prediction and the third item configuration feature to the item hub machine learning component 302 of the composite machine learning model 300. For example, the second field item prediction may be representative of an item material impact value (e.g., a cost or utility associated with the material in an item of the plurality of items). In this regard, in some embodiments, the item hub machine learning component 302 of the composite machine learning model 300 is configured to determine an item material impact value associated with an item of the plurality of items, from an item weight and a raw material impact value. For example, the item hub machine learning component 302 of the composite machine learning model 300 may be configured to determine an item weight associated with an item from an item schematic when item feature data received by the item optimization and generation device 140 includes an item configuration feature representative of an item schematic, which can be used to determine an item weight, but does not include an item configuration feature representative of an item material impact value.

In some embodiments, the item hub machine learning component 302 of the composite machine learning model 300 may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to determine one or more field item predictions. In this regard, in some embodiments, the item hub machine learning component 302 of the composite machine learning model 300 may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. In this regard, in some embodiments, the item hub machine learning component 302 of the composite machine learning model 300 is configured to determine and/or predict one or more field item predictions that that are not possible to determine and/or predict using existing databases, existing computing devices, and/or associated data transformation techniques. For example, the item hub machine learning component 302 of the composite machine learning model 300 may be configured to determine and/or predict one or more field item predictions that are not possible using inner joins, outer joins, right joins, and/or left joins in an existing SQL database.

In some embodiments, the item hub machine learning component 302 of the composite machine learning model 300 is one component of the composite machine learning model 300. In this regard, in some embodiments, the item hub machine learning component 302 of the composite machine learning model 300 is configured to communicate with one or more other components of the composite machine learning model 300, one or more other components of the item optimization and generation device 140, and/or one or more devices external to the item optimization and generation device 140 via a bus 312.

In some embodiments, the item optimization and generation device 140 is configured to generate a field item feature structure. In some embodiments, the field item feature structure is associated with the plurality of items associated with the item feature data. In some embodiments, a field item feature structure is a data structure that includes an aggregation of item feature data and field item predictions. In some embodiments, the aggregation of item feature data and field item predictions in a field item feature structure may be organized in an at least partially ordered structure. In some embodiments, the item optimization and generation device 140 is configured to generate a field item feature structure in response to receiving item feature data and/or determining one or more field item predictions. Additionally, or alternatively, the item optimization and generation device 140 is configured to generate a field item feature structure in response to a request to determine one or more available field spaces. In some embodiments, the item optimization and generation device 140 is configured to generate a field item feature structure using the item hub machine learning component 302 of the composite machine learning model 300.

In some embodiments, the item optimization and generation device 140 is configured to determine one or more available field spaces. In this regard, in some embodiments, the item optimization and generation device 140 is configured to determine one or more available field spaces using a field item feature structure, such as a field item feature structure associated with the plurality of items. In some embodiments, an available field space is a space, an area, a domain, and/or the like in which an item identified by the item optimization and generation device 140, such as an item in the plurality of items and/or a first item, is not used and/or implemented in. Said differently, an available field space may be a space, an area, a domain, and/or the like that is different than the one or more field spaces that are associated with an item, such as the first item, when it is identified by the item optimization and generation device 140. In some embodiments, the item optimization and generation device 140 is configured to determine one or more available field spaces by performing one or more mining techniques on a field item feature structure. For example, the item optimization and generation device 140 may be configured to determine one or more available field spaces by performing a data mining technique on a field item feature structure. In some embodiments, the item optimization and generation device 140 is configured to perform the one or more mining techniques using the item hub machine learning component 302 of the composite machine learning model 300. In some embodiments, the one or more available field spaces correspond to and/or are one or more item data objects.

In some embodiments, the item optimization and generation device 140 is configured to identify one or more images associated with the first item. In some embodiments, the first item is one of the plurality of items associated with the item feature data and/or an associated field item feature structure generated using the item feature data. In some embodiments, the first item is not one of the plurality of items associated with the item feature data and/or an associated field item feature structure generated using the item feature data.

In some embodiments, the one or more images include images of the first item. For example, the one or more images may include images of the first item that includes a printed circuit board (PCB), a printed circuit board assembly (PCBA), a sensor, bar code scanner, and/or the like. In some embodiments, the one or more images include individual images of the first item, such as individual still images of the first item. For example, the one or more images may include one or more photos of the first item. In some embodiments, the one or more images include a series of images of the first item. For example, the one or more images may include a video of the first item. In some embodiments, the one or more images are captured using visible light, infrared, x-rays, and/or the like. In some embodiments, the one or more images include one or more tear down images of the first item. In this regard, for example, tear down images may include images of the first item after the first item has been taken apart and split into its components. As another example, tear down images may include images of the first item as the first item is being taken apart and split into the first item's components. Said differently, in some embodiments, the one or more images include tear down images that are configured to convey the first item's design, the first item's components, the first item's manufacturing process, and/or the like.

In some embodiments, identifying one or more images associated with the first item includes the item optimization and generation device 140 being configured to receive one or more images. For example, the item optimization and generation device 140 may be configured to receive one or more images from the user device 160, and/or one or more other sources (e.g., remote sources). Additionally, or alternatively, identifying one or more images includes the item optimization and generation device 140 being configured to generate the one or more images associated with the first item. In this regard, for example, the item optimization and generation device 140 may include one or more image capture components (e.g., a camera) configured to capture one or more images.

In some embodiments, the item optimization and generation device 140 is configured to generate first reconfiguration data. In some embodiments, first reconfiguration data includes one or more items of data representative and/or indicative of one or more item configuration features associated with the first item that are determined by the tear down machine learning component 304 of the composite machine learning model 300. For example, first reconfiguration data may be representative of one or more item configuration features associated with the first item that are representative and/or indicative of a material from which the first item is constructed (e.g., the material of a layer of a PCB), a component of the first item (e.g., an electrical component, such as a capacitor, of a PCBA), a manufacturing process used to create and/or generate the first item (e.g., steps used to manufacture the first item), a machining process used to create and/or generate the first item (e.g., tools used to create a housing of a sensor), and/or the like. In this regard, in some embodiments, the tear down machine learning component 304 may be configured to generate first reconfiguration data representative and/or indicative of one or more item configuration features associated with the first item using one or more images associated with the first item. As another example, the tear down machine learning component 304 may be configured to generate first reconfiguration data representative and/or indicative of one or more item configuration features associated with the first item by extracting item configuration features associated with the first item from the field item feature structure. In some embodiments, first reconfiguration data that includes one or more items of data representative and/or indicative of one or more item configuration features associated with the first item that are determined by the tear down machine learning component 304 of the composite machine learning model 300 is a first portion of the first reconfiguration data.

Additionally, or alternatively, in some embodiments, first reconfiguration data is representative and/or indicative of one or more first actions that may be performed to alter the first item such that the first item is associated with an available field space of the one or more available field spaces that are determined by applying one or more images to a tear down machine learning component 304 of the composite machine learning model 300. In this regard, in some embodiments, first reconfiguration data is representative and/or indicative of one or more first actions for altering the first item such that the first item can be implemented and/or used in a space, an area, a domain and/or the like in which the first item is not currently being implemented and/or used. For example, first reconfiguration data may include one or more first actions that may be performed to alter the first item such that the first item is associated with an available field space of the one or more available field spaces that include altering the first item by changing the material of the first item. In this regard, for example, changing a material of the first item may increase the functionality of the first item such that the first item can be used and/or implemented in an available field space of the one or more available field spaces.

As another example, first reconfiguration data may include one or more first actions that may be performed to alter the first item such that the first item is associated with an available field space of the one or more available field spaces that include altering the first item by manufacturing the first item an alternative manufacturing process. In this regard, for example, manufacturing the first item using an alternative manufacturing process may decrease an impact value (e.g., a cost) associated with the first item such that the first item can be used and/or implemented in an available field space of the one or more available field spaces. As another example, first reconfiguration data may include one or more first actions that may be performed to alter the first item such that the first item is associated with an available field space of the one or more available field spaces that include altering the first item by adjusting the packaging of the first item. In this regard, for example, adjusting the packaging of the first item may increase the durability of the first item such that the first item can be used and/or implemented in an available field space of the one or more available field spaces. As another example, first reconfiguration data may include one or more first actions that may be performed to alter the first item such that the first item is associated with an available field space of the one or more available field spaces that include altering the first item by redesigning a component of the first item. In this regard, for example, altering the first item by redesigning a component of the first item may increase the functionality of the first item such that the first item can be used and/or implemented in an available field space of the one or more available field spaces. In some embodiments, first reconfiguration data that is representative and/or indicative of one or more first actions that may be performed to alter the first item such that the first item is associated with an available field space of the one or more available field spaces that are determined by applying one or more images to a tear down machine learning component 304 of the composite machine learning model 300 is a second portion of the first reconfiguration data.

In some embodiments, the tear down machine learning component 304 may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate first reconfiguration data. In this regard, in some embodiments, the tear down machine learning component 304 may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. For example, the tear down machine learning component 304 may be configured to employ computer vision techniques to analyze one or more images to identify one or more first actions that may be performed to alter the first item such that the first item is associated with an available field space of the one or more available field spaces. In some embodiments, the tear down machine learning component 304 is one component of the composite machine learning model 300. In this regard, in some embodiments, the tear down machine learning component 304 is configured to communicate with one or more other components of the composite machine learning model 300 via a bus 312.

In some embodiments, the item optimization and generation device 140 is configured to extract external related item data from the one or more external sources 180. In some embodiments, the one or more external sources 180 comprise an internet-based source. In some embodiments, external related item data includes one or more items of data representative and/or indicative of the related item. In this regard, for example, the related item may be an item that is related to the first item. In some embodiments, the related item is related to the first item because the related item and the first item have one or more features that are similar and/or in common with each other. For example, the related item and the first item may be related because the related item and the first item may have a common or similar manufacturing bill of materials (MBOM), a common or similar component specification, a common or similar manufacturing process and specification, a common or similar provider detail specification, and/or the like.

In some embodiments, the external related item data includes one or more related images. In some embodiments, the one or more related images include images of the related item. For example, the one or more related images may include images of a related item that includes a printed circuit board (PCB), a printed circuit board assembly (PCBA), a sensor, bar code scanner, and/or the like. In some embodiments, the one or more related images include individual images of the related item, such as individual still images of the related item. For example, the one or more related images may include one or more photos of the related item. In some embodiments, the one or more related images include a series of images of the related item. For example, the one or more related images may include a video of the related item. In some embodiments, the one or more related images are captured using visible light, infrared, x-rays, and/or the like. In some embodiments, the one or more related images include one or more tear down images of the related item. In this regard, for example, tear down images may include images of the related item after the related item has been taken apart and split into its components. As another example, tear down images may include images of the related item as the related item is being taken apart and split into the related item's components. Said differently, in some embodiments, the one or more related images include tear down images that are configured to convey the related item's design, the related item's components, the related item's manufacturing process, and/or the like.

In some embodiments, the related item extraction machine learning component 306 may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to extract external related item data from the one or more external sources 180. In this regard, in some embodiments, the related item extraction machine learning component 306 may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. For example, if the related item extraction machine learning component 306 may be configured to employ one or more fuzzy similarity techniques to identify and extract external related item data that is indicative of the related item based on the related item's commonality with the first item. In some embodiments, the related item extraction machine learning component 306 is one component of the composite machine learning model 300. In this regard, in some embodiments, the related item extraction machine learning component 306 is configured to communicate with one or more other components of the composite machine learning model 300 via a bus 312.

In some embodiments, the item optimization and generation device 140 is configured to generate second reconfiguration data. In some embodiments, the item optimization and generation device 140 is configured to generate second reconfiguration data using a comparative machine learning component 308 of the composite machine learning model 300. In some embodiments, the comparative machine learning component 308 may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate second reconfiguration data. In this regard, in some embodiments, the comparative machine learning component 308 may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. In some embodiments, the comparative machine learning component 308 is one component of the composite machine learning model 300. In this regard, in some embodiments, the comparative machine learning component 308 is configured to communicate with one or more other components of the composite machine learning model 300 via a bus 312.

In some embodiments, generating second reconfiguration data includes the comparative machine learning component 308 identifying one or more features of the first item. In some embodiments, the one or more features of the first item are identified using the one or more images and one or more computer vision techniques. Additionally, or alternatively, one or more features of the first item are identified using first reconfiguration data that is generated by the tear down machine learning component 304. In some embodiments, generating second reconfiguration data includes the comparative machine learning component 308 identifying one or more features of the related item. In some embodiments, the one or more features of the related item are identified using external related item data. For example, the one or more features of the related item may be identified using one or more related images associated with the external related item data and/or using one or more computer vision techniques. In some embodiments, generating second reconfiguration data includes the comparative machine learning component 308 determining one or more differences between the features of the first item and the features of the related item.

In some embodiments, generating second reconfiguration data includes the comparative machine learning component 308 determining one or more second actions that may be performed to alter the first item such that the first item is associated with an available field space of the one or more available field spaces. In this regard, in some embodiments, second reconfiguration data includes one or more items of data representative and/or indicative of one or more second actions that may be performed to alter the first item such that the first item is associated with an available field space of the one or more available field spaces that are determined by applying one or more images and/or external related item data to the comparative machine learning component 308. Additionally, or alternatively, second reconfiguration data includes one or more items of data representative and/or indicative of one or more second actions that may be performed to alter the first item such that the first item is associated with an available field space of the one or more available field spaces that are determined by applying an item specification associated with the first item and/or an item specification associated with the related item to the comparative machine learning component 308 of the composite machine learning model 300. Said differently, for example, the one or more second actions represented by the second reconfiguration data may be actions that may be performed to alter the first item such that the first item is associated with an available field space of the one or more available field spaces based on one or more differences between the first item and the related item. In this regard, in some embodiments, second reconfiguration data is representative and/or indicative of one or more second actions that may be performed to alter the first item such that the first item is associated with an available field space of the one or more available field spaces that include reducing the number of components of the first item. For example, if the comparative machine learning component 308 determines that the related item has the same or similar functionality as the first item but uses fewer components, second reconfiguration data may be representative and/or indicative of one or more actions that include replacing components of the first item with the same type of components as used in the related item. In this regard, for example, replacing components of the first item with the same type of components as used in the related item may decrease an impact value (e.g., a cost) associated with the first item such that the first item can be used and/or implemented in an available field space of the one or more available field spaces.

In some embodiments, the item optimization and generation device 140 is configured to generate new item data by applying the first portion of the first reconfiguration data to an implementation machine learning component 310 of the composite machine learning model 300. In some embodiments, the implementation machine learning component 310 of the composite machine learning model 300 corresponds to and/or is an environment analysis machine learning component. In some embodiments, generating the new item data comprises item optimization and generation device 140 being configured to identify a first available field space of the one or more available field spaces. For example, the item optimization and generation device 140 may be configured to identify a first available field space of the one or more available field spaces using the implementation machine learning component 310. In this regard, in some embodiments, the first available field space is a space, an area, a domain, and/or the like in which the first item is not currently used and/or implemented in. Said differently, for example, the implementation machine learning component 310 may be configured to determine that the first item does not match the first available field space by determining that the first item is not currently used and/or implemented in the first available field space. Additionally, or alternatively, the first available field space is a space, an area, a domain, and/or the like in which it is not possible to implement and/or use the first item in. Said differently, for example, the implementation machine learning component 310 may be configured to determine that the first item does not match the first available field space by determining that it is not possible to implement and/or use the first item in the first available field space.

In some embodiments, generating the new item data comprises item optimization and generation device 140 being configured to identify a second item. For example, the item optimization and generation device 140 may be configured to identify a second item using the implementation machine learning component 310. In some embodiments, the second item may be an item that is not currently associated with the item optimization and generation device 140. For example, the second item may be an item that is not currently included in the plurality of items associated with the field item feature structure generated by the item optimization and generation device 140. As another example, the second item may be an item that is different than the first item. In this regard, in some embodiments, new item data includes one or more items of data representative and/or indicative of the second item.

In some embodiments, the implementation machine learning component 310 may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate new item data. In this regard, in some embodiments, the implementation machine learning component 310 may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. In some embodiments, the comparative machine learning component 308 is one component of the composite machine learning model 300. In this regard, in some embodiments, the implementation machine learning component 310 is configured to communicate with one or more other components of the composite machine learning model 300 via a bus 312.

In some embodiments, the item optimization and generation device 140 is configured to initiate performance of one or more item related actions. In some embodiments, the item optimization and generation device 140 is configured to initiate performance of one or more item related actions based on first reconfiguration data, second reconfiguration data, and/or new item data. In this regard, in some embodiments, initiating performance of one or more item related actions includes the item optimization and generation device 140 being configured to generate an item optimization interface component 402. In some embodiments, the item optimization interface component 402 includes a first reconfiguration interface element 404 configured to display first reconfiguration data. In some embodiments, the item optimization interface component 402 includes a second reconfiguration interface element 406 configured to display second reconfiguration data. In some embodiments, the item optimization interface component 402 includes a new item interface element 408 configured to display new item data. For example, the new item interface element 408 may be configured to display new item data representative of the second item.

In some embodiments, initiating performance of item related actions includes the item optimization and generation device 140 being configured to cause the item optimization interface component 402 to be rendered to an item optimization interface 400. In some embodiments, the item optimization interface 400 may be provided on item optimization and generation device 140. Additionally, or alternatively, the item optimization interface 400 may be provided on the user device 160. Additionally, or alternatively, the item optimization interface 400 may be provided on one or more other devices, such as a remote device.

In some embodiments, initiating performance of one or more item related actions includes the item optimization and generation device 140 being configured to generate a first item and related item comparison report. In some embodiments, the item optimization and generation device 140 is configured to generate a first item and related item comparison report using first reconfiguration data, second reconfiguration data, one or more images associated with the first item, external related item data, and/or the like. In this regard, in some embodiments, the first item and related item comparison report is a report that provides a comparison between the first item and the related item. In some embodiments, the first item and related item comparison report may be in a tabular format. In some embodiments, the first item and related item comparison report may include one or more images associated with the first item and/or one or more related item images. In some embodiments, initiating performance of one or more item related actions may include causing the first item and related item comparison report to be provided on the item optimization interface component 402. In some embodiments, the first item and related item comparison report is generated using the composite machine learning model 300. For example, the first item and related item comparison report may be generated using the implementation machine learning component 310 and/or the comparative machine learning component 308.

In some embodiments, initiating performance of one or more item related actions includes the item optimization and generation device 140 being configured to cause an item inventory record to be modified. In some embodiments, an item inventory record is a record that indicates all of the components that are in the first item. In this regard, for example, an item inventory record may be modified to remove a component from the item inventory record, such as when first reconfiguration data is representative of an action that includes altering the first item by reducing the number of components in the item. In some embodiments, modifying an item inventory record to remove a component may cause a transmission to be sent to a supplier to cancel an order for the removed component. Additionally, or alternatively, an item inventory record is a record that indicates all of the components that are in the second item. In this regard, for example, an item inventory record may be modified to add components of the second item to the inventory record. In some embodiments, modifying an item inventory record to add components of the second item may cause a transmission to be sent to a supplier place an order for the added components.

### Example Methods

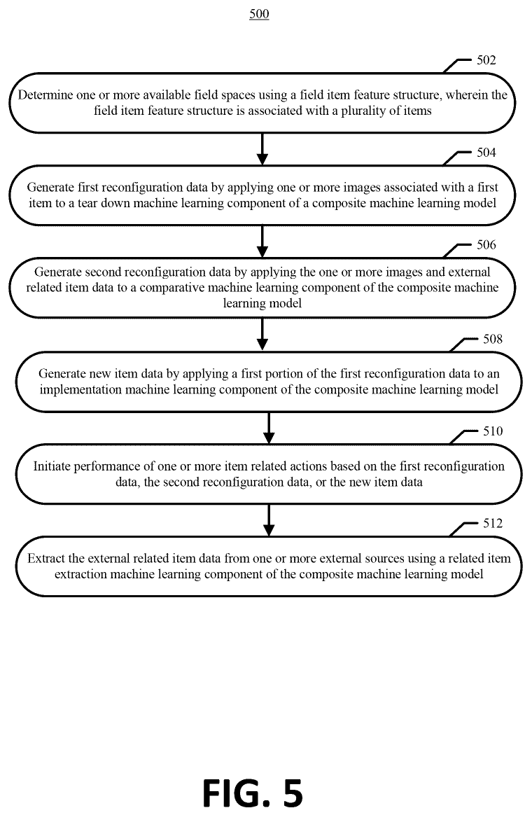

Referring now to FIG. 5, a flowchart providing an example method 500 is illustrated. In this regard, FIG. 5 illustrates operations that may be performed by the one or more of the item optimization and generation device 140, the user device 160, and/or the like. In some embodiments, the method 500 includes operations for initiating performance of one or more item related actions. In some embodiments, the example method 500 defines a process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 500.

As shown in block 502, the method 500 may include determining one or more available field spaces using a field item feature structure, wherein the field item feature structure is associated with a plurality of items. As described above, in some embodiments, the item optimization and generation device is configured to determine one or more available field spaces using a field item feature structure, such as a field item feature structure associated with the plurality of items. In some embodiments, an available field space is a space, an area, a domain, and/or the like in which an item identified by the item optimization and generation device, such as an item in the plurality of items and/or a first item, is not used and/or implemented in. Said differently, an available field space may be a space, an area, a domain, and/or the like that is different than the one or more field spaces that are associated with an item, such as the first item, when it is identified by the item optimization and generation device. In some embodiments, the item optimization and generation device is configured to determine one or more available field spaces by performing one or more mining techniques on a field item feature structure. For example, the item optimization and generation device may be configured to determine one or more available field spaces by performing a data mining technique on a field item feature structure. In some embodiments, the item optimization and generation device is configured to perform the one or more mining techniques using the item hub machine learning component of the composite machine learning model. In some embodiments, the one or more available field spaces correspond to and/or are one or more item data objects.

As shown in block 504, the method 500 may include generating first reconfiguration data by applying one or more images associated with a first item to a tear down machine learning component of a composite machine learning model. As described above, in some embodiments, first reconfiguration data includes one or more items of data representative and/or indicative of one or more item configuration features associated with the first item that are determined by the tear down machine learning component of the composite machine learning model. For example, first reconfiguration data may be representative of one or more item configuration features associated with the first item that are representative and/or indicative of a material from which the first item is constructed (e.g., the material of a layer of a PCB), a component of the first item (e.g., an electrical component, such as a capacitor, of a PCBA), a manufacturing process used to create and/or generate the first item (e.g., steps used to manufacture the first item), a machining process used to create and/or generate the first item (e.g., tools used to create a housing of a sensor), and/or the like. In this regard, in some embodiments, the tear down machine learning component may be configured to generate first reconfiguration data representative and/or indicative of one or more item configuration features associated with the first item using one or more images associated with the first item. As another example, the tear down machine learning component may be configured to generate first reconfiguration data representative and/or indicative of one or more item configuration features associated with the first item by extracting item configuration features associated with the first item from the field item feature structure. In some embodiments, first reconfiguration data that includes one or more items of data representative and/or indicative of one or more item configuration features associated with the first item that are determined by the tear down machine learning component of the composite machine learning model is a first portion of the first reconfiguration data.

Additionally, or alternatively, in some embodiments, first reconfiguration data is representative and/or indicative of one or more first actions that may be performed to alter the first item such that the first item is associated with an available field space of the one or more available field spaces that are determined by applying one or more images to a tear down machine learning component of the composite machine learning model. In this regard, in some embodiments, first reconfiguration data is representative and/or indicative of one or more first actions for altering the first item such that the first item can be implemented and/or used in a space, an area, a domain and/or the like in which the first item is not currently being implemented and/or used. For example, first reconfiguration data may include one or more first actions that may be performed to alter the first item such that the first item is associated with an available field space of the one or more available field spaces that include altering the first item by changing the material of the first item. In this regard, for example, changing a material of the first item may increase the functionality of the first item such that the first item can be used and/or implemented in an available field space of the one or more available field spaces.

As another example, first reconfiguration data may include one or more first actions that may be performed to alter the first item such that the first item is associated with an available field space of the one or more available field spaces that include altering the first item by manufacturing the first item an alternative manufacturing process. In this regard, for example, manufacturing the first item using an alternative manufacturing process may decrease an impact value (e.g., a cost) associated with the first item such that the first item can be used and/or implemented in an available field space of the one or more available field spaces. As another example, first reconfiguration data may include one or more first actions that may be performed to alter the first item such that the first item is associated with an available field space of the one or more available field spaces that include altering the first item by adjusting the packaging of the first item. In this regard, for example, adjusting the packaging of the first item may increase the durability of the first item such that the first item can be used and/or implemented in an available field space of the one or more available field spaces. As another example, first reconfiguration data may include one or more first actions that may be performed to alter the first item such that the first item is associated with an available field space of the one or more available field spaces that include altering the first item by redesigning a component of the first item. In this regard, for example, altering the first item by redesigning a component of the first item may increase the functionality of the first item such that the first item can be used and/or implemented in an available field space of the one or more available field spaces. In some embodiments, first reconfiguration data that is representative and/or indicative of one or more first actions that may be performed to alter the first item such that the first item is associated with an available field space of the one or more available field spaces that are determined by applying one or more images to a tear down machine learning component of the composite machine learning model is a second portion of the first reconfiguration data.

In some embodiments, the tear down machine learning component may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate first reconfiguration data. In this regard, in some embodiments, the tear down machine learning component may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. For example, the tear down machine learning component may be configured to employ computer vision techniques to analyze one or more images to identify one or more first actions that may be performed to alter the first item such that the first item is associated with an available field space of the one or more available field spaces. In some embodiments, the tear down machine learning component is one component of the composite machine learning model. In this regard, in some embodiments, the tear down machine learning component is configured to communicate with one or more other components of the composite machine learning model via a bus.

As shown in block 506, the method 500 may include generating second reconfiguration data by applying the one or more images and external related item data to a comparative machine learning component of the composite machine learning model. As described above, in some embodiments, the item optimization and generation device is configured to generate second reconfiguration data using a comparative machine learning component of the composite machine learning model. In some embodiments, the comparative machine learning component may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate second reconfiguration data. In this regard, in some embodiments, the comparative machine learning component may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. In some embodiments, the comparative machine learning component is one component of the composite machine learning model. In this regard, in some embodiments, the comparative machine learning component is configured to communicate with one or more other components of the composite machine learning model via a bus.

In some embodiments, generating second reconfiguration data includes the comparative machine learning component identifying one or more features of the first item. In some embodiments, the one or more features of the first item are identified using the one or more images and one or more computer vision techniques. Additionally, or alternatively, one or more features of the first item are identified using first reconfiguration data that is generated by the tear down machine learning component. In some embodiments, generating second reconfiguration data includes the comparative machine learning component identifying one or more features of the related item. In some embodiments, the one or more features of the related item are identified using external related item data. For example, the one or more features of the related item may be identified using one or more related images associated with the external related item data and/or using one or more computer vision techniques. In some embodiments, generating second reconfiguration data includes the comparative machine learning component determining one or more differences between the features of the first item and the features of the related item.

In some embodiments, generating second reconfiguration data includes the comparative machine learning component determining one or more second actions that may be performed to alter the first item such that the first item is associated with an available field space of the one or more available field spaces. In this regard, in some embodiments, second reconfiguration data includes one or more items of data representative and/or indicative of one or more second actions that may be performed to alter the first item such that the first item is associated with an available field space of the one or more available field spaces that are determined by applying one or more images and/or external related item data to the comparative machine learning component. Additionally, or alternatively, second reconfiguration data includes one or more items of data representative and/or indicative of one or more second actions that may be performed to alter the first item such that the first item is associated with an available field space of the one or more available field spaces that are determined by applying an item specification associated with the first item and/or an item specification associated with the related item to the comparative machine learning component of the composite machine learning model. Said differently, for example, the one or more second actions represented by the second reconfiguration data may be actions that may be performed to alter the first item such that the first item is associated with an available field space of the one or more available field spaces based on one or more differences between the first item and the related item. In this regard, in some embodiments, second reconfiguration data is representative and/or indicative of one or more second actions that may be performed to alter the first item such that the first item is associated with an available field space of the one or more available field spaces that include reducing the number of components of the first item. For example, if the comparative machine learning component determines that the related item has the same or similar functionality as the first item but uses fewer components, second reconfiguration data may be representative and/or indicative of one or more actions that include replacing components of the first item with the same type of components as used in the related item. In this regard, for example, replacing components of the first item with the same type of components as used in the related item may decrease an impact value (e.g., a cost) associated with the first item such that the first item can be used and/or implemented in an available field space of the one or more available field spaces.

As shown in block 508, the method 500 may include generating new item data by applying a first portion of the first reconfiguration data to an implementation machine learning component of the composite machine learning model. As described above, in some embodiments, the implementation machine learning component of the composite machine learning model corresponds to and/or is an environment analysis machine learning component. In some embodiments, generating the new item data comprises item optimization and generation device being configured to identify a first available field space of the one or more available field spaces. For example, the item optimization and generation device may be configured to identify a first available field space of the one or more available field spaces using the implementation machine learning component. In this regard, in some embodiments, the first available field space is a space, an area, a domain, and/or the like in which the first item is not currently used and/or implemented in. Said differently, for example, the implementation machine learning component may be configured to determine that the first item does not match the first available field space by determining that the first item is not currently used and/or implemented in the first available field space. Additionally, or alternatively, the first available field space is a space, an area, a domain, and/or the like in which it is not possible to implement and/or use the first item in. Said differently, for example, the implementation machine learning component may be configured to determine that the first item does not match the first available field space by determining that it is not possible to implement and/or use the first item in the first available field space.

In some embodiments, generating the new item data comprises item optimization and generation device being configured to identify a second item. For example, the item optimization and generation device may be configured to identify a second item using the implementation machine learning component. In some embodiments, the second item may be an item that is not currently associated with the item optimization and generation device. For example, the second item may be an item that is not currently included in the plurality of items associated with the field item feature structure generated by the item optimization and generation device. As another example, the second item may be an item that is different than the first item. In this regard, in some embodiments, new item data includes one or more items of data representative and/or indicative of the second item.

In some embodiments, the implementation machine learning component may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to generate new item data. In this regard, in some embodiments, the implementation machine learning component may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. In some embodiments, the comparative machine learning component is one component of the composite machine learning model. In this regard, in some embodiments, the implementation machine learning component is configured to communicate with one or more other components of the composite machine learning model via a bus.

As shown in block 510, the method 500 may include initiating performance of one or more item related actions based on the first reconfiguration data, the second reconfiguration data, or the new item data. As described above, in some embodiments, the item optimization and generation device is configured to initiate performance of one or more item related actions based on first reconfiguration data, second reconfiguration data, and/or new item data.

As shown in block 512, the method 500 may include extracting the external related item data from one or more external sources using a related item extraction machine learning component of the composite machine learning model. As described above, in some embodiments, the one or more external sources comprise an internet-based source. In some embodiments, external related item data includes one or more items of data representative and/or indicative of the related item. In this regard, for example, the related item may be an item that is related to the first item. In some embodiments, the related item is related to the first item because the related item and the first item have one or more features that are similar and/or in common with each other. For example, the related item and the first item may be related because the related item and the first item may have a common or similar manufacturing bill of materials (MBOM), a common or similar component specification, a common or similar manufacturing process and specification, a common or similar provider detail specification, and/or the like.

In some embodiments, the external related item data includes one or more related images. In some embodiments, the one or more related images include images of the related item. For example, the one or more related images may include images of a related item that includes a printed circuit board (PCB), a printed circuit board assembly (PCBA), a sensor, bar code scanner, and/or the like. In some embodiments, the one or more related images include individual images of the related item, such as individual still images of the related item. For example, the one or more related images may include one or more photos of the related item. In some embodiments, the one or more related images include a series of images of the related item. For example, the one or more related images may include a video of the related item. In some embodiments, the one or more related images are captured using visible light, infrared, x-rays, and/or the like. In some embodiments, the one or more related images include one or more tear down images of the related item. In this regard, for example, tear down images may include images of the related item after the related item has been taken apart and split into its components. As another example, tear down images may include images of the related item as the related item is being taken apart and split into the related item's components. Said differently, in some embodiments, the one or more related images include tear down images that are configured to convey the related item's design, the related item's components, the related item's manufacturing process, and/or the like.

In some embodiments, the related item extraction machine learning component may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to extract external related item data from the one or more external sources. In this regard, in some embodiments, the related item extraction machine learning component may be configured to utilize one or more of any type of machine learning, rules-based, and/or artificial intelligence techniques including one or more of computer vision techniques, supervised learning (e.g., using user feedback), unsupervised learning, semi-supervised learning, reinforcement learning, computer vision techniques, sequence modeling techniques, language processing techniques, neural network techniques, and/or generative artificial intelligence techniques. For example, if the related item extraction machine learning component may be configured to employ one or more fuzzy similarity techniques to identify and extract external related item data that is indicative of the related item based on the related item's commonality with the first item. In some embodiments, the related item extraction machine learning component is one component of the composite machine learning model. In this regard, in some embodiments, the related item extraction machine learning component is configured to communicate with one or more other components of the composite machine learning model via a bus.

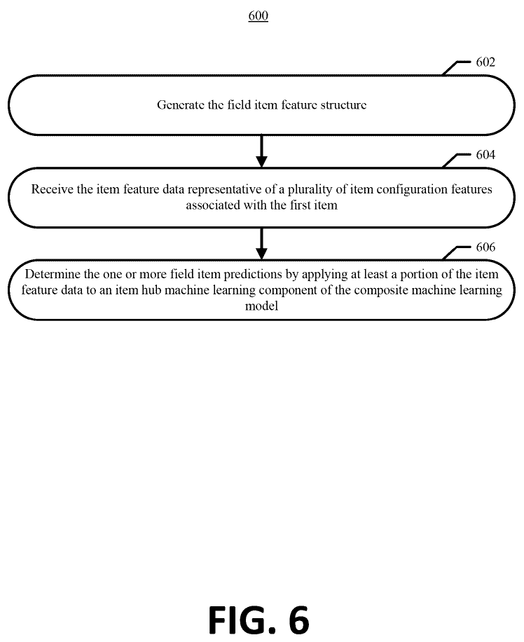

Referring now to FIG. 6, a flowchart providing an example method 600 is illustrated. In this regard, FIG. 6 illustrates operations that may be performed by the one or more of the item optimization and generation device 140, the user device 160, and/or the like. In some embodiments, the method 600 includes operations for generating a field item feature structure. In some embodiments, the example method 600 defines a process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As shown in block 602, the method 600 may include generating the field item feature structure. As described above, in some embodiments, the field item feature structure is associated with the plurality of items associated with the item feature data. In some embodiments, a field item feature structure is a data structure that includes an aggregation of item feature data and field item predictions. In some embodiments, the aggregation of item feature data and field item predictions in a field item feature structure may be organized in an at least partially ordered structure. In some embodiments, the item optimization and generation device is configured to generate a field item feature structure in response to receiving item feature data and/or determining one or more field item predictions. Additionally, or alternatively, the item optimization and generation device is configured to generate a field item feature structure in response to a request to determine one or more available field spaces. In some embodiments, the item optimization and generation device is configured to generate a field item feature structure using the item hub machine learning component of the composite machine learning model.

As shown in block 604, the method 600 may include receiving the item feature data representative of a plurality of item configuration features associated with the first item. As described above, in some embodiments, the item feature data is associated with a plurality of items. In some embodiments, an item includes an electrical item, a mechanical item, an electromechanical item, a resin item, and/or the like. For example, an item may include a printed circuit board (PCB), a printed circuit board assembly (PCBA), a sensor, a bar code scanner, and/or the like. In some embodiments, an item includes one or more components that form a portion of an item. For example, a component of an item may include a portion of a printed circuit board (PCB) (e.g., an individual layer of a printed circuit board), a portion of a printed circuit board assembly (PCBA) (e.g., an individual electrical component of a printed circuit board assembly), a portion of a sensor (e.g., a controller of a sensor), a portion of a bar code scanner (e.g., an imagining component of a bar code scanner), and/or the like.

In some embodiments, an item is associated with one or more field spaces. In some embodiments, a field space is a space, an area, a domain, and/or the like in which an item is used or implemented. For example, if an item includes a printed circuit board (PCB), an item may be associated with an electrical applications field space.

In some embodiments, item feature data includes one or more items of data representative and/or indicative of a plurality of item configuration features. For example, item feature data may include one or more items of data representative and/or indicative of a plurality of item configuration features associated with one or more of the plurality of items. In some embodiments, an item configuration feature is a data object that is representative and/or indicative of a feature, characteristic, component, specification, report, schematic, and/or the like associated with an item. In some embodiments, a first part of item feature data is received from the internal item feature database. Additionally, or alternatively, a second part of item feature data is received from an external item feature database.

As shown in block 606, the method 600 may include determining the one or more field item predictions by applying at least a portion of the item feature data to an item hub machine learning component of the composite machine learning model. As described above, in some embodiments, a field item prediction is a data object that is representative and/or indicative of an item configuration feature that is not represented in the item feature data and is determined by the item optimization and generation device. Said differently, for example, by determining one or more field item predictions, the item optimization and generation device may be configured to use item feature data that represents at least some of the item configuration features in the plurality of item configuration features to determine and/or predict other item configuration features associated with a particular item(s) of the plurality of items.

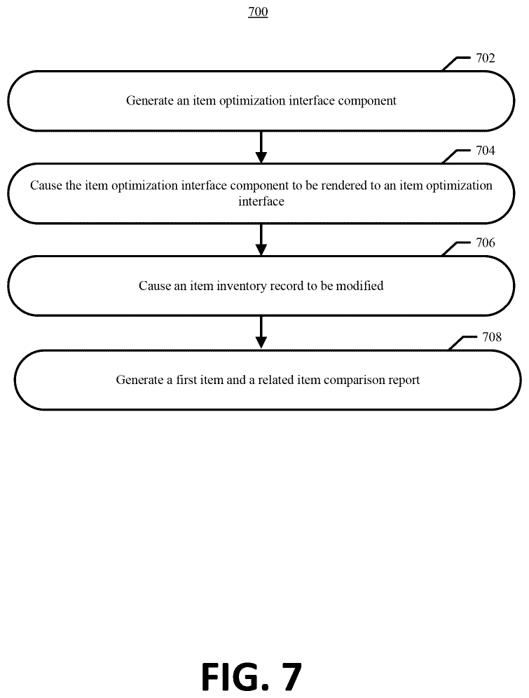

Referring now to FIG. 7, a flowchart providing an example method 700 is illustrated. In this regard, FIG. 7 illustrates operations that may be performed by the one or more of the item optimization and generation device 140, the user device 160, and/or the like. In some embodiments, the method 700 includes operations for generating a field item feature structure. In some embodiments, the example method 700 defines a process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 may include generating an item optimization interface component. As described above, in some embodiments, the item optimization interface component includes a first reconfiguration interface element configured to display first reconfiguration data. In some embodiments, the item optimization interface component includes a second reconfiguration interface element configured to display second reconfiguration data. In some embodiments, the item optimization interface component includes a new item interface element configured to display new item data. For example, the new item interface element may be configured to display new item data representative of the second item.

As shown in block 704, the method 700 may include causing the item optimization interface component to be rendered to an item optimization interface. As described above, in some embodiments, the item optimization interface may be provided on item optimization and generation device. Additionally, or alternatively, the item optimization interface may be provided on the user device. Additionally, or alternatively, the item optimization interface may be provided on one or more other devices, such as a remote device.

As shown in block 706, the method 700 may include causing an item inventory record to be modified. As described above, in some embodiments, the item optimization and generation device is configured to generate a first item and related item comparison report using first reconfiguration data, second reconfiguration data, one or more images associated with the first item, external related item data, and/or the like. In this regard, in some embodiments, the first item and related item comparison report is a report that provides a comparison between the first item and the related item. In some embodiments, the first item and related item comparison report may be in a tabular format. In some embodiments, the first item and related item comparison report may include one or more images associated with the first item and/or one or more related item images. In some embodiments, initiating performance of one or more item related actions may include causing the first item and related item comparison report to be provided on the item optimization interface component. In some embodiments, the first item and related item comparison report is generated using the composite machine learning model. For example, the first item and related item comparison report may be generated using the implementation machine learning component and/or the comparative machine learning component.

As shown in block 708, the method 700 may include generating a first item and a related item comparison report. As described above, in some embodiments, an item inventory record is a record that indicates all of the components that are in the first item. In this regard, for example, an item inventory record may be modified to remove a component from the item inventory record, such as when first reconfiguration data is representative of an action that includes altering the first item by reducing the number of components in the item. In some embodiments, modifying an item inventory record to remove a component may cause a transmission to be sent to a supplier to cancel an order for the removed component. Additionally, or alternatively, an item inventory record is a record that indicates all of the components that are in the second item. In this regard, for example, an item inventory record may be modified to add components of the second item to the inventory record. In some embodiments, modifying an item inventory record to add components of the second item may cause a transmission to be sent to a supplier place an order for the added components.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
determining one or more available field spaces using a field item feature structure, wherein the field item feature structure is associated with a plurality of items;
generating first reconfiguration data by applying one or more images associated with a first item to a tear down machine learning component of a composite machine learning model;
generating second reconfiguration data by applying the one or more images and external related item data to a comparative machine learning component of the composite machine learning model, wherein the external related item data is associated with a related item, wherein the first reconfiguration data and the second reconfiguration data are associated with at least one of the one or more available field spaces;
generating new item data by applying a first portion of the first reconfiguration data to an implementation machine learning component of the composite machine learning model; and
initiating performance of one or more item related actions based on the first reconfiguration data, the second reconfiguration data, or the new item data.

2. The method of claim 1, wherein the field item feature structure comprises item feature data and one or more field item predictions.

3. The method of claim 2, further comprising:
generating the field item feature structure.

4. The method of claim 3, wherein generating the field item feature structure comprises:
receiving the item feature data representative of a plurality of item configuration features associated with the first item; and
determining the one or more field item predictions by applying at least a portion of the item feature data to an item hub machine learning component of the composite machine learning model.

5. The method of claim 1, further comprising:
extracting the external related item data from one or more external sources using a related item extraction machine learning component of the composite machine learning model.

6. The method of claim 1, wherein the tear down machine learning component is configured to perform one or more computer vision techniques.

7. The method of claim 1, wherein determining the one or more available field spaces comprises performing a mining technique on the field item feature structure.

8. The method of claim 1, wherein generating the new item data comprises:
identifying a first available field space of the one or more available field spaces;
determining that the first item does not match the first available field space of the one or more available field spaces;
identifying a second item; and
determining that the second item matches the first available field space of the one or more available field spaces.

9. The method of claim 1, wherein initiating performance of the one or more item related actions comprises:
generating an item optimization interface component, wherein the item optimization interface component comprises one or more of the first reconfiguration data, the second reconfiguration data, or the new item data; and
causing the item optimization interface component to be rendered to an item optimization interface.

10. The method of claim 1, wherein initiating performance of the one or more item related actions comprises:
causing an item inventory record to be modified.

11. The method of claim 1, wherein initiating performance of the one or more item related actions comprises:
generating a first item and a related item comparison report.

12. An apparatus comprising memory and one or more processors communicatively coupled to the memory, the one or more processors configured to:
determine one or more available field spaces using a field item feature structure, wherein the field item feature structure is associated with a plurality of items; generate first reconfiguration data by applying one or more images associated with a first item to a tear down machine learning component of a composite machine learning model;
generate second reconfiguration data by applying the one or more images and external related item data to a comparative machine learning component of the composite machine learning model, wherein the external related item data is associated with a related item, wherein the first reconfiguration data and the second reconfiguration data are associated with at least one of the one or more available field spaces;
generate new item data by applying a first portion of the first reconfiguration data to an implementation machine learning component of the composite machine learning model; and
initiate performance of one or more item related actions based on the first reconfiguration data, the second reconfiguration data, or the new item data.

13. The apparatus of claim 12, wherein the field item feature structure comprises item feature data and one or more field item predictions.

14. The apparatus of claim 13, wherein the one or more processors are further configured to:
generate the field item feature structure.

15. The apparatus of claim 14, wherein to generate the field item feature structure the one or more processors are further configured to:
receive the item feature data representative of a plurality of item configuration features associated with the first item; and
determine the one or more field item predictions by applying at least a portion of the item feature data to an item hub machine learning component of the composite machine learning model.

16. The apparatus of claim 12, wherein to generate the new item data the one or more processors are further configured to:
identify a first available field space of the one or more available field spaces;
determine that the first item does not match the first available field space of the one or more available field spaces;
identify a second item; and
determine that the second item matches the first available field space of the one or more available field spaces.

17. The apparatus of claim 12, wherein to initiate performance of the one or more item related actions the one or more processors are further configured to:
generate an item optimization interface component, wherein the item optimization interface component comprises one or more of the first reconfiguration data, the second reconfiguration data, or the new item data; and
cause the item optimization interface component to be rendered to an item optimization interface.

18. The apparatus of claim 12, wherein to initiate performance of the one or more item related actions the one or more processors are further configured to:
cause an item inventory record to be modified.

19. The apparatus of claim 12, wherein to initiate performance of the one or more item related actions the one or more processors are further configured to:
generate a first item and a related item comparison report.

20. A computer program product comprising at least one non-transitory computer-readable storage medium having computer program code stored thereon that, in execution with at least one processor, configures the computer program product for:
determining one or more available field spaces using a field item feature structure, wherein the field item feature structure is associated with a plurality of items;
generating first reconfiguration data by applying one or more images associated with a first item to a tear down machine learning component of a composite machine learning model;
generating second reconfiguration data by applying the one or more images and external related item data to a comparative machine learning component of the composite machine learning model, wherein the external related item data is associated with a related item, wherein the first reconfiguration data and the second reconfiguration data are associated with at least one of the one or more available field spaces;
generating new item data by applying a first portion of the first reconfiguration data to an implementation machine learning component of the composite machine learning model; and
initiating performance of one or more item related actions based on the first reconfiguration data, the second reconfiguration data, or the new item data.
